(19) United States
(12) Patent Application Publication
(10) Pub. No.: US 2010/0134441 A1
(43) Pub. Date: Jun. 3, 2010

(54) STRUCTURE OF OPTIC TOUCH CONTROL SCREEN MODULE

(76) Inventors: JUNG-YU CHEN, Taipei (TW); Chien-Ping Sun, Taipei (TW); Yi-Te Chien, Taipei (TW); Wei-Lin Wang, Taipei (TW)

Correspondence Address: LEONG C LEI, PMB # 1008, 1867 YGNACIO VALLEY ROAD, WALNUT CREEK, CA, 94598, US

(21) Appl. No.: 12/416,162

(22) Filed: Apr. 1, 2009

(30) Foreign Application Priority Data
Nov. 28, 2008 (TW) 097221436

(51) Int. Cl. G06F 3/042

(52) U.S. Cl. 345/175

(57) ABSTRACT

An optic touch control screen module includes a plurality of frame members of various sizes and joint members that are combined to form a frame. Each of the frame members and the joint members forms a receiving chamber. Every two opposite ones of the circuit boards are provided with oppositely arranged and corresponding optic transmitting elements and optic receiving elements. Each circuit board has opposite ends each forming a female connector. A plurality of male connectors is provided and each has a structure having two faces forming male terminals. To assemble, the male connector is set between and engages with the female connectors of two adjacent circuit boards. Thus, damage to the circuit boards can be avoided.

### (a) TECHNICAL FIELD OF THE INVENTION

The present invention generally relates to a structure of an optic touch control screen module, and particularly to an optic touch control screen module that provides improved engagement between segments of an internal circuit board assembly of the module.

### (b) DESCRIPTION OF THE PRIOR ART

Popularization of optic touch control screen in the current trend of market and this is simply because the use of the touch control screen is convenient and easy, especially for the occasion and uses in business, education, and presentation. With the touch control screen, operation of computer systems is made easy and mistakes or drawbacks caused by for example error actuation, invasion of debris and dusts, and fatigues of springs occurring in input operation with a keyboard can be effectively eliminated. Thus, optic touch control screens especially large-sized ones, are becoming an essential component for devices with large screen, such as computers.

To cope with the needs for convenience in warehousing and transportation after manufacturing, the structure of large-sized optic touch control screen is changed from an integrally formed frame into a structure that is formed by combining several pieces, including circuit boards of various sizes. Connection between the circuit boards of the optic touch control screen, which are often rigid, is done by a Flexible Flat Cable (FFC) connecting between the rigid circuit boards. A drawback of the FFC connection is that the FFC can be easily detached due to undesired impact occurring in the assembling with an enclosure of the module, leading to improper engagement for signal transmission. Further, in carrying out the connection operation, since the FFC is often set with quit a length, the FFC must be properly organized and fixed before the assembling of the enclosure. Such a fixing operation causes additional troubles to the manufacturer or the assembling line operators and is adverse to the manufacturing operation for additional work time is needed.

An alternative solution to connect the circuit boards is to arrange a plurality of circuit boards inside a frame-like enclosure and every two adjacent circuit boards are set to engage with each other to form a frame-like circuit board assembly. FIGS. 5 and 6 show an example, wherein circuit boards 10, 11 of different sizes are provided at ends thereof opposing each other with male and female connectors 20, 21 respectively by soldering. Preferably, the connectors 20, 21 are mateable male and female connectors so that by properly mating the male and female connectors 20, 21, electrical and signal connection can be realized between circuit boards.

Such an arrangement, however, is disadvantageous to warehousing and assembling of the touch screen module for the male connectors 20 of the circuit boards 10, 11 are easily damage due to the susceptibility of pin terminals of the male connectors becoming deformed due to undesired contact or impact. This prevents correct engagement during the mating operation and once the male connector is broken, the whole circuit board 10, 11 is considered unusable, leading to increased manufacturing costs. Even the damage is only minor, the circuit board, after repairing, is not deemed a product of high quality, and may eventually lead to deterioration of the quality of the final product.

### SUMMARY OF THE INVENTION

A primary objective of the present invention is to provide a structure of an optic touch control screen module, wherein circuit boards of the module are provided at opposite ends thereof with female connectors to replace male connectors having projecting pin terminals and a bidirectional male connector is additionally provided to connect two adjacent circuit boards by engaging the female connectors, whereby component damage caused by undesired impact or contact during the manufacturing and transportation of semi-finished products can be reduced and the costs are reduced.

To achieve the above objective, the present invention provides an optic touch control screen module, wherein a plurality of frame members of various sizes and joint members are provided to combine to form a frame. Each of the frame members and the joint members forms a receiving chamber. A plurality of circuit boards is provided with optic transmitting elements and optic receiving elements at opposing sides of oppositely arranged circuit boards. Each circuit board has opposite ends each forming a female connector. A plurality of male connectors is provided and each has a structure having two faces forming male terminals, whereby the two faces respectively engage the female connectors of two adjacent circuit boards that are to be connected together. Thus, efficient connection can be realized and damage to the components can be avoided.

The foregoing objective and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a structure in accordance with the present invention.

FIG. 2 is a perspective view showing a circuit boards assembly in accordance with the present invention.

FIG. 3 is an exploded view of the circuit board assembly.

FIG. 4 is a cross-sectional of the circuit board assembly in an assembled form.

FIG. 5 is an exploded view showing a portion of a circuit board assembly used in a conventional optic touch control screen.

FIG. 6 is an explode view showing the portion of the circuit board assembly of the conventional optic touch control screen in an assembled form.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

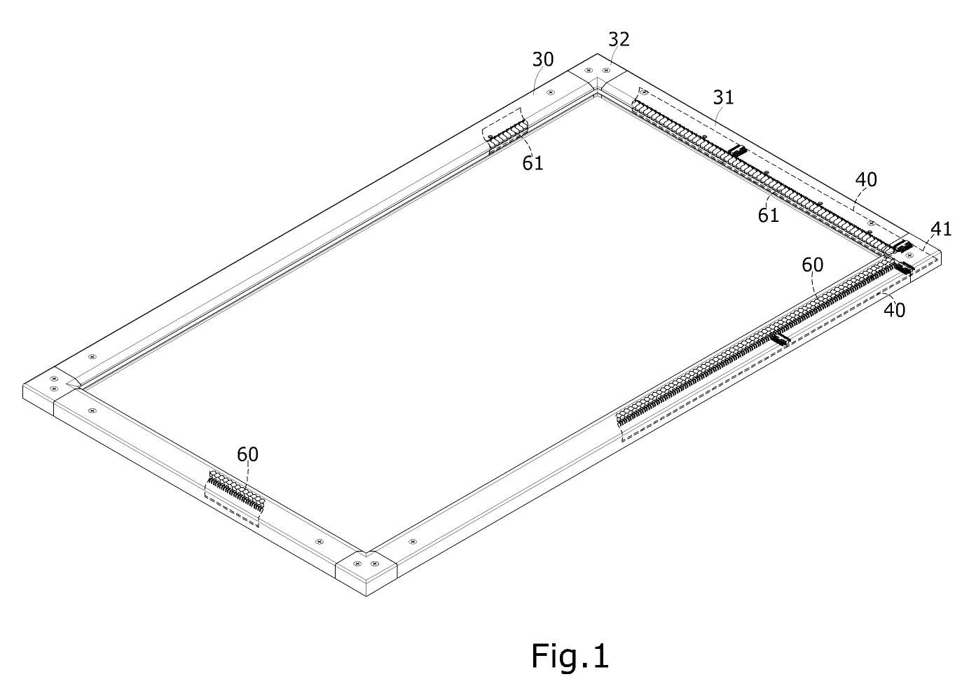

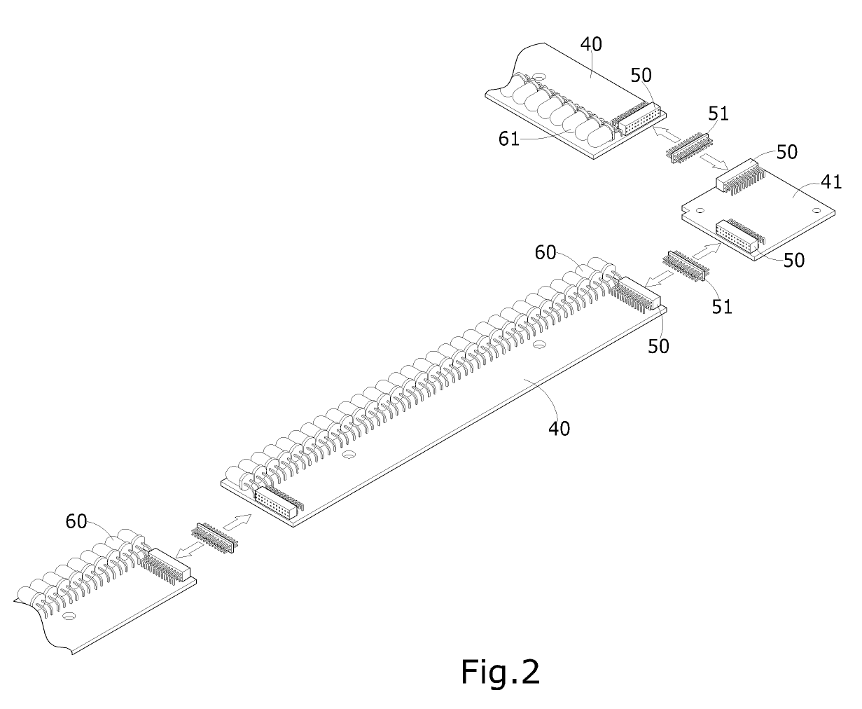

With reference to the drawings and in particular to FIGS. 1 and 2, the present invention provide an optic touch control screen module, which comprises a plurality of frame members 30, 31, which are of different sizes, and joint members 32, and the frame members and the joint members are connected together to form a frame. The frame members 30, 31 and the joint members 32 form therein internal receiving chambers that receive and retain a plurality of corresponding circuit boards 40, 41.

Referring to FIGS. 2-4, every two of the circuit boards 40, 41 that are opposite to each other respectively form, on the opposing sides thereof, optic transmitting elements 60 and optic receiving elements 61 that are opposite to each other. Opposite ends of each of the circuit boards 40, 41 form female connectors 50 respectively.

A plurality of bidirectional male connectors 51, each comprising a structure having two opposite faces forming male terminals, is each arranged between the female connectors 50 of two adjacent circuit boards 40, 41 to be connected.

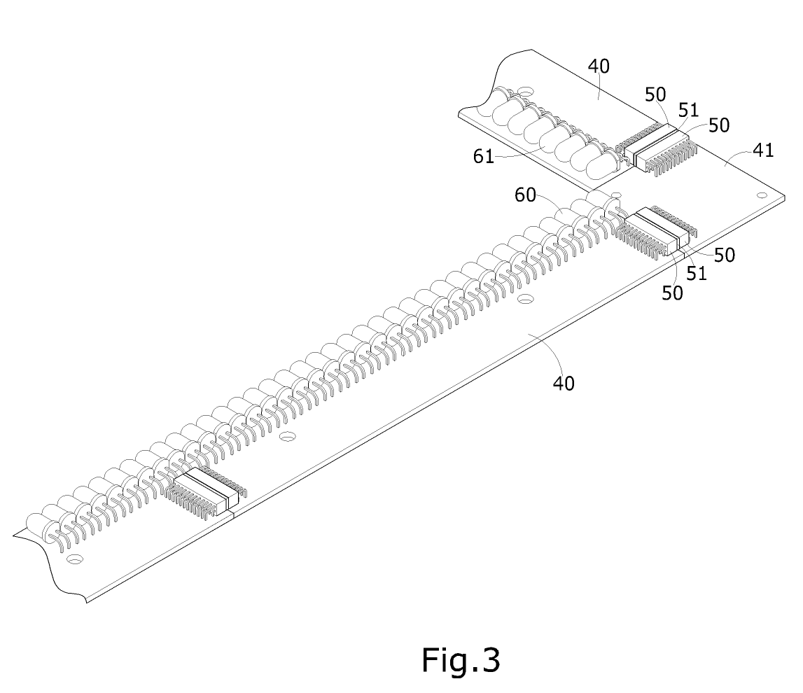

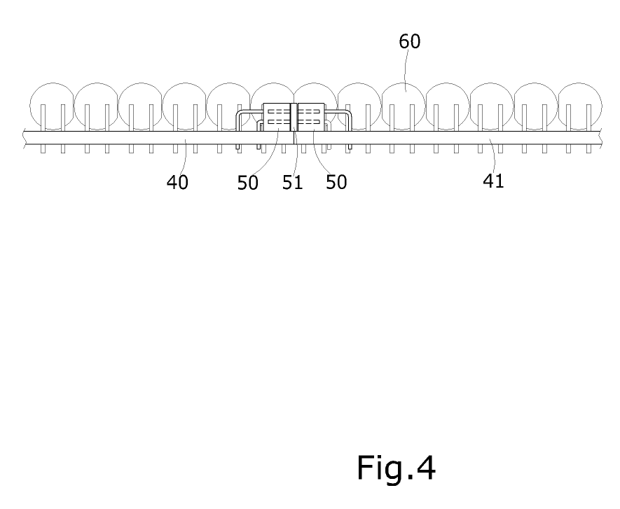

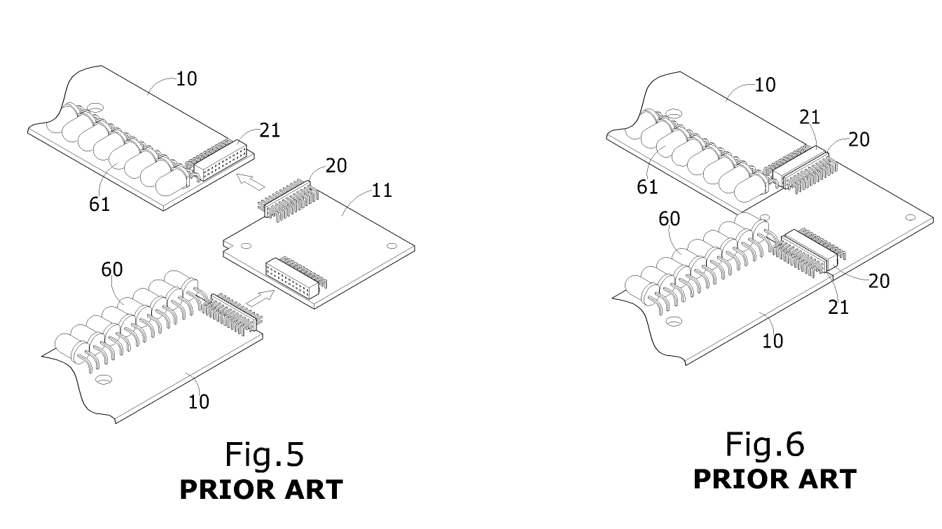

Thus, in respect of manufacturing, the present invention allows the plurality of frame members 30, 31, the joint members 32, the circuit boards, 40, 41, and the bidirectional male connectors 51 to be manufactured separately. Since the opposite ends of each circuit board 40, 41 are both provided with female connectors 50, the ends of the circuit board 40 comprise no terminals that project beyond the ends. This eliminates the risk of damage caused by unexpected or accidental contact or impact during the manufacturing, transportation, or assembly. To assemble, as shown in FIG. 2, each of the bidirectional male connectors 51 is positioned between two opposing female connectors 50 of two adjacent circuit boards 40, 41 and then, as shown in FIGS. 3 and 4, the circuit boards 40, 41 are connected with the male connector 51 engaging both female connectors 50. Afterwards, the circuit boards are fit into the frame members 30, 31 and the joint members 32 to form the frame shown in FIG. 1. The assembling operation is easy and simple.

Thus, the present invention offers the following advantages:

(1) During the manufacturing and transportation, the risk of damaging the terminals on ends of the circuit boards 40, 41 that are elongate members due to undesired impact or contact can be eliminated and thus, effective protection of the components against damage can be realized.

(2) Connection of circuit boards can be simply done through arranging and engaging a male connector 51 between opposing female connectors 50 of two adjacent circuit boards 40, 41 and even the male connector 51 is damaged, the expense is low and no additional damage and cost will be incurred for the circuit boards 40, 41. Economic loss will be reduced.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An optic touch control screen module comprising:
a plurality of frame members and joint members that is combinable to form a frame, each of the frame members and the joint members forming a receiving chamber;
a plurality of circuit boards respectively set in the receiving chambers of the frame members and the joint members, the circuit boards having opposing inner sides that are provided with corresponding and oppositely arranged optic transmitting elements and optic receiving elements, each circuit board having opposite ends each forming a female connector; and
a plurality of male connectors, each comprising a structure having two faces forming male terminals to respectively engage two female connectors of two adjacent ones of the circuit boards that are connected by the male connector.
